(19) United States
(12) Patent Application Publication
(10) Pub. No.: US 2025/0055068 A1
(43) Pub. Date: Feb. 13, 2025

(54) INTER-CELL COOLING DEVICE WITH INTEGRATED HEATING DEVICE, BATTERY MODULE AND COOLING DEVICE FOR A BATTERY MODULE

(71) Applicant: AUDI AG, Ingolstadt (DE)

(72) Inventors: Uwe GERLINGER, Kipfenberg (DE); Carsten LORENZ, Reichertshofen (DE); Eduard MAIN, Buxheim (DE)

(73) Assignee: AUDI AG, Ingolstadt (DE)

(21) Appl. No.: 18/796,599

(22) Filed: Aug. 7, 2024

(30) Foreign Application Priority Data
Aug. 11, 2023 (DE) 102023121520.5

(51) Int. Cl. H01M 10/6557; H01M 10/613; H01M 10/615; H01M 10/63

(52) U.S. Cl. CPC H01M 10/6557; H01M 10/613; H01M 10/615; H01M 10/63

(57) ABSTRACT

An inter-cell cooling device for arrangement in an intermediate space between two battery cells arranged adjacent to one another in a stacking direction. The inter-cell cooling device has a first side wall with a first outer side for arrangement on a first cell side and a second side wall opposite the first side wall with respect to a first direction and with a second outer side for arrangement on a second cell side, as well as a heating device designed as a heating layer for heating the inter-cell cooling device. With respect to the first direction, at least one cooling channel through which a coolant can flow is formed between the first and second side wall as part of the central inter-cell cooling region of the inter-cell cooling device, and the heating layer is designed to heat a coolant located in the at least one cooling channel.

### FIELD

The invention relates to an inter-cell cooling device for arrangement in an intermediate space between two battery cells of a cell stack arranged adjacent to one another in a stacking direction, wherein the part of the inter-cell cooling device which, when the inter-cell cooling device is arranged in the intermediate space, is located entirely within the intermediate space, represents a central inter-cell cooling region. The inter-cell cooling device comprises a first side wall with a first outer side for arrangement on a first cell side of one of the two adjacent battery cells, a second side wall opposite the first side wall with respect to a first direction and having a second outer side for arrangement on a second cell side of the other of the two adjacent battery cells and a heating device designed as a heating layer for heating the inter-cell cooling device. Furthermore, it also relates to a battery module and a cooling device for a battery module.

### BACKGROUND

Battery modules, for example for high-voltage batteries in motor vehicles, can be made up of several battery cells that form a cell stack. Often, the cells of such a cell stack are cooled by a cooling device that is designed as a cooling plate to which only one side of the cell stack is connected. However, this only allows one-sided cooling of the battery cells, and also on a side of the battery cells that is very small in terms of area.

DE 21 2019 000 290 U1 describes a thermal management system for a vehicle having an energy storage system including a plurality of rechargeable battery units, the thermal management system comprising a circulation circuit for circulating a first volume of a heat transfer fluid for cooling or heating the battery, a plurality of battery heat exchangers provided in the circulation circuit, each of the battery heat exchangers being in thermal contact with one or more of the battery units, each of the battery heat exchangers having an internal fluid flow channel and a plurality of fluid openings including an inlet and an outlet of the internal fluid flow channel, and an electrical heating element integrated into a first battery heat exchanger of the plurality of battery heat exchangers so as to heat the heat transfer fluid flowing through the internal fluid flow channel of the first heat exchanger. The heat exchanger may be designed as a cold plate heat exchanger comprising a flat plate which defines as an outer surface a flat surface on which a plurality of battery cells and/or battery modules are stacked.

However, more efficient temperature control of the battery cells can be achieved if temperature control elements are arranged in the intermediate spaces between the cells, as these can then be brought into contact with the sides of the battery cells with the largest surface area.

For this purpose, WO 2012/120 090 A1 describes an electrical energy storage device with a battery module with a plurality of individual cells arranged in a stack between two outer end plates, wherein at least one individual cell is arranged in an individual module. It is provided that a preferably flexible electrical heating element is arranged between at least two individual cells, preferably between two individual modules. This can be designed as a flexible heating foil, which is surrounded by a cooling plate made of sheet metal as a cooling element, which is folded around the heating element, wherein the cooling element and the heating element are glued to each other and form-fittingly connected to each other. This is intended to avoid coolant connections and cooling channels that require a lot of installation space.

### SUMMARY

The object of the present invention is to provide an inter-cell cooling device, a battery module and a cooling device, which allow the most efficient and energy-saving temperature control of battery cells possible.

This object is achieved by an inter-cell cooling device, a battery module and a cooling device.

The invention relates to an inter-cell cooling device for arrangement in an intermediate space between two battery cells of a cell stack arranged adjacent to one another in a stacking direction, wherein the part of the inter-cell cooling device which, when the inter-cell cooling device is arranged in the intermediate space, is located entirely within the intermediate space, represents a central inter-cell cooling region. The inter-cell cooling device comprises a first side wall with a first outer side for arrangement on a first cell side of one of the two adjacent battery cells, a second side wall opposite the first side wall with respect to a first direction and having a second outer side for arrangement on a second cell side of the other of the two adjacent battery cells and a heating device designed as a heating layer for heating the inter-cell cooling device. In this case, with respect to the first direction, at least one cooling channel through which a coolant can flow is formed between the first and second side walls as part of the central inter-cell cooling region, and the heating layer is designed to heat a coolant located in the at least one cooling channel.

To cool and/or heat the battery cells, a coolant can advantageously flow through the inter-cell cooling device. This allows, especially for cooling purposes, a significantly more efficient cooling than, for example, purely passive cooling using cooling plates through which no coolant can flow. The heat can thus be transported away from the side walls of the inter-cell cooling device much more efficiently. At the same time, the heating layer can provide particularly energy-saving and rapid heating of the battery cells, since the heat can be generated locally where it is needed to heat the battery cells, namely in the immediate vicinity of the battery cells themselves. The heating layer can thus advantageously heat both the side walls of the inter-cell cooling device and the coolant located in at least one cooling channel, which also makes it possible to provide a particularly homogeneous heat distribution across the inter-cell cooling device, in particular in the central inter-cell cooling region. In addition, a liquid coolant can be used as a coolant, for example a water-based coolant, so that due to its very high heat capacity, part of the heat generated by the heating layer can also be stored and released over a longer period of time, which also enables a more homogeneous, even and gentler heating of the adjacent cell sides. In addition, the possibility of integrating a cooling channel through which a coolant can flow between the side walls means that the heating effect of the heating layer can also be controlled by controlling the coolant flow through the cooling channel, as will be explained in more detail later. For example, the flow through the cooling channel can be reduced or switched off when the heating layer is activated in order to specifically keep the heat generated by the heating layer in the inter-cell cooling region and release it to the cells, while by activating the flow one can quickly switch back to cooling mode in order to dissipate the heat to be dissipated by the cells as quickly as possible.

The heating device is preferably an electric heating device. The heating device can also have electrical connections to supply power to the heating layer. The heating layer can, for example, comprise a heating wire which is arranged on a carrier element or is embedded in such a element, or also a flat heating element to which voltage can be applied in order to generate a heating current. The connections for the heating device can be provided outside the inter-cell cooling region.

The two side walls are also at least largely or completely part of the central inter-cell cooling region. In addition, the inter-cell cooling device can optionally comprise fluid connections in order to supply a coolant to the at least one cooling channel and to discharge it again after it has flowed through the cooling channel. However, the inter-cell cooling device can also be designed as an open-flow inter-cell cooling device. For this purpose, the inter-cell cooling device can be formed with high cooling channel ends on two end faces which are opposite one another with respect to a second direction which is in particular perpendicular to the first direction, for example over an entire height of the intermediate space or at least a large part of the height of the intermediate space. The two side walls can therefore be spaced apart from one another in the first direction to form the at least one cooling channel and, for example, can be sealed or connected to one another at the top and bottom with respect to a third direction and can be unsealed or unconnected with respect to the second direction.

If the inter-cell cooling is arranged as intended between the two battery cells, the first side wall with its first outer side preferably lies flat against the first cell side and the second outer side of the second side wall lies flat against the second cell side. The dimensions of the first and second side walls with respect to the second and third directions can essentially correspond to the dimensions of the first and second cell sides, respectively. This essentially allows the entire adjacent cell side to be cooled or heated.

The side walls can also be designed to be relatively thin, for example with a wall thickness of a few millimeters or even less than one millimeter. The side walls can thus be made flexible and/or even provided in the form of foils. This allows the side walls to fit snugly against the adjacent cell sides. This reduces the thermal resistance between the inter-cell cooling device and the adjacent battery cells. If the inter-cell cooling device is arranged in the cell stack as intended, the stacking direction corresponds to the first direction.

In a further very advantageous embodiment of the invention, the heating layer is formed as the first and/or second side wall and/or integrated into the first and/or second side wall. This makes it possible to save an additional component for providing the heating layer, since the heating layer can be provided by the first and/or second side wall itself. In other words, the first and/or second side wall can be designed as a heating wall and thereby provide the heating layer. In principle, it is sufficient if only one of the two side walls is designed as such a heating wall, i.e. it encloses the heating layer or represents it. However, it is also conceivable that the inter-cell cooling device has two heating layers, one of which is integrated into the first side wall and the other into the second side wall.

In this case, the heating layer also preferably extends over the entire first and/or second side wall. In other words, if the heating layer is integrated into the first and/or second side wall, the heating structure of the heating layer, which can be supplied with an electric current for heating purposes, should extend substantially over the entire side wall in question. The heating structure can be distributed uniformly over the respective side wall so that a substantially uniform heating of the side wall by the heating layer is possible.

In a further advantageous embodiment of the invention, the inter-cell cooling device has an intermediate wall which is arranged between the first and second side walls with respect to the first direction, wherein the heating layer is designed as the intermediate wall and/or is part of the intermediate wall. This represents a particularly advantageous embodiment of the invention, since such an intermediate wall, which is provided in addition to the first and second side walls, can also take on additional functions, as will be described in more detail later. In addition, the integration of the heating layer into such an intermediate wall or the design of such an intermediate wall as a heating wall enables more uniform heating of the two adjacent battery cells. For example, if the heating layer is integrated into only one side wall, the cell side of the battery cell adjacent to this side wall is heated more than the cell side adjacent to the opposite side wall. By means of an additional intermediate wall, the two battery cells adjacent to the inter-cell cooling device can be heated more evenly and the heat can be distributed more evenly across the two side walls.

In principle, it is also conceivable to arrange such an intermediate wall in direct contact with the inside of one of the two side walls. However, it is very advantageous if the intermediate wall is arranged as centrally as possible between the first and second side walls with respect to the first direction. An average distance between the intermediate wall and the first side wall can then be the same as an average distance between the intermediate wall and the second side wall. An average distance is present when the intermediate wall does not have a constant distance to the first or second side wall. However, the intermediate wall can also be flat and arranged at a constant distance from the first side wall and the second side wall, wherein this distance from the first and second side walls is preferably as equal as possible or is equal.

In an advantageous embodiment of the invention, the heating layer extends over a large part of a length and width of the central inter-cell cooling region and preferably over an entire length and width of the central inter-cell cooling region perpendicular to the first direction. This is advantageous both when the heating layer is integrated into the first and/or second side wall and when the heating layer is provided by the intermediate wall. This makes it possible to provide particularly uniform heating over the entire length and width, in particular over the entire cross-sectional area of the inter-cell cooling device perpendicular to the first direction.

In a further advantageous embodiment of the invention, the inter-cell cooling device in the central inter-cell cooling region comprises at least one support element which is arranged in contact on a first inner side of the first side wall opposite the first outer side of the first side wall on the one hand and on a second inner side of the second side wall opposite the second outer side of the second side wall on the other hand and locally supports the first side wall against the second side wall. This design is particularly advantageous, especially when the first and second side walls are thin-walled and flexible. This can advantageously prevent the inter-cell cooling device and in particular the at least one cooling channel from not being compressed or from being compressed to a lesser extent by the contact pressure exerted by the cells on the inter-cell cooling device. A cell stack is usually clamped by means of a clamping device, which results in a certain contact pressure of the cells adjacent to the inter-cell cooling device on the inter-cell cooling device. In addition, the battery cells swell over the course of their service life and also cyclically during each charging and discharging process. These swelling forces can now advantageously be at least partially absorbed by the at least one support element. The inter-cell cooling device can also comprise several such support elements. These can, for example, be distributed at specific points in the interior, i.e. in the region between the two side walls, for example according to a uniform pattern, or can also be provided in the form of support webs which extend perpendicular to the first direction. In addition, the at least one support element can be at least partially flexible or elastic in order to allow a certain flexibility of the inter-cell cooling device, which is advantageous for the swelling compensation described above.

The at least one support element can therefore advantageously ensure that a certain flow cross-section through the inter-cell cooling device or the cooling channel integrated therein is maintained even in the event of very strong swelling forces.

It represents a particular embodiment of the invention if the at least one support element is provided by the intermediate wall. In other words, the intermediate wall can take over the above-described support function of the at least one support element. Therefore, no separate support elements need to be provided. Accordingly, it is advantageous if the intermediate wall is not merely designed as a type of foil, but has a certain rigidity in order to take on this supporting function.

Therefore, it represents a further advantageous embodiment of the invention if the intermediate wall has a first wall side and a second wall side opposite the first wall side with respect to the first direction, wherein a distance of the first wall side from the second wall side defines a wall thickness of the intermediate wall, wherein the first wall side and/or the second wall side is formed with a surface geometry different from a plane, and the first wall side locally contacts the first inner side and the second wall side locally contacts the second inner side, in particular wherein the intermediate wall has a substantially constant wall thickness in the central inter-cell cooling region. The intermediate wall can, for example, be geometrically shaped in such a way that it alternately rests against the first side wall and the second side wall, for example similarly to a corrugated sheet. This allows the support function described above to be integrated into the intermediate wall in a particularly advantageous manner. This also makes it possible to form defined flow channels through the intermediate wall. For example, the intermediate wall can separate the space between the two side walls into two sub-regions, namely a first sub-region between the first side wall and the intermediate wall and a second sub-region between the second side wall and the intermediate wall, wherein these sub-regions can in turn be divided into further sub-regions by the geometric design of the intermediate wall, for example the first sub-region into a plurality of first sub-regions, each of which represents first cooling channels through which a coolant can flow, and the second sub-region into a plurality of second sub-regions, each of which provides second cooling channels through which a coolant can flow. These first and second cooling channels can be completely fluidically separated from each other, at least within the central inter-cell cooling region, or they can also be fluidically connected to each other. Furthermore, the intermediate wall can also be designed with openings, for example a specific hole pattern, to allow the cooling medium to flow through the intermediate wall. Thus also the first sub-region and the second sub-region are fluidically connected to one another.

The contact regions between the respective wall sides and the inner sides of the side walls can, for example, be designed in a point-like or circular manner or also in a linear manner, in particular in the form of lines parallel to one another.

In order to achieve this, there are various options for the geometric design of the intermediate wall, which are explained in more detail below. For example, the intermediate wall may have a plurality of elevations and depressions in the first direction with respect to an imaginary center plane perpendicular to the first direction. These can also be linear elevations and depressions. This means that the intermediate wall can be designed in such a way that the elevations and depressions alternate along the intermediate wall in the second direction and also in the third direction. However, the intermediate wall can also be designed in such a way that the elevations and depressions alternate only in the second direction or only in the third direction, whereby a cross-section through the intermediate wall, for example perpendicular to the second direction or perpendicular to the third direction, then always remains constant or has a constant or identical geometry.

In a further very advantageous embodiment of the invention, the intermediate wall is corrugated. The intermediate wall therefore has a corrugated structure. This corrugated structure can be implemented for both the first and second wall sides. As already mentioned above, it is preferred that the wall thickness of the intermediate wall in the central inter-cell cooling region is essentially constant. The first and second wall sides can therefore be designed with a complementary corrugated structure. This means that where there is an elevation on the first wall side, there is a depression on the corresponding second wall side and vice versa. A wavy course has the great advantage that this geometric structure can also provide a certain elasticity in the first direction. This is very advantageous in order to enable the support function described above and a certain swelling compensation.

According to a further advantageous embodiment of the invention, the intermediate wall runs in a zigzag shape. The intermediate wall can therefore be designed in a similar way to that described for the corrugated course, with the difference that the contact regions with the respective inner sides of the first and second side walls are designed as tips of such a zigzag-shaped wall rather than as curves, as would be the case with the corrugated course.

In a further advantageous embodiment of the invention, the intermediate wall is meander-shaped. The contact surfaces to the first and second inner side can be made slightly wider accordingly.

In principle, the geometric designs described can also be combined in the same intermediate wall, for example by designing different regions of the intermediate wall with different such structures. However, the intermediate wall is preferably designed with a uniform structure, which enables a more even temperature distribution and easier production.

The side walls and the intermediate wall can basically be made of any material. The heating device comprises at least one electrical conductor, since it is preferably designed as an electrical heating device. This can be embedded in a corresponding wall structure or panel structure, in particular in a carrier material, which in turn can be chosen arbitrarily, for example metallic and/or made of plastic. It is preferred that the side walls are made of a metallic material, as this allows particularly good heat conduction. The side walls are preferably made of aluminum due to its good thermal conductivity, but a structure made of other materials or material combinations is also conceivable. Accordingly, the side walls can also be referred to as sheets. The side walls and/or the intermediate wall can be glued and/or welded to one another, for example in edge regions or also in the connection regions of the intermediate wall to the two side walls in the central inter-cell cooling region and/or joined by another method.

The heating layer can be controlled by applying a voltage. The heating device heats up and transfers its heat to the outer panels via the direct connection to the side walls, but also indirectly via the cooling fluid.

Furthermore, the invention also relates to a battery module having a inter-cell cooling device according to the invention or one of its embodiments.

According to a further advantageous embodiment of the invention, the battery module comprises a cell stack which comprises at least two battery cells arranged adjacent to one another in a stacking direction, wherein the inter-cell cooling device is arranged in a space between the two battery cells.

Such a cell stack can also have more than two battery cells. These can also be arranged next to each other in a stacking direction. Between each two battery cells of such a cell stack arranged adjacently in the stacking direction there is an intermediate space in which such an inter-cell cooling device can be arranged.

The battery cells are preferably designed as pouch cells or prismatic cells. Moreover, the battery cells can be formed as lithium-ion cells.

Furthermore, the invention also relates to a battery, in particular a high-voltage battery for a motor vehicle, which can have one or more of the battery modules according to the invention or one of its embodiments.

Also a motor vehicle having such a battery module according to the invention or one of its embodiments should be regarded as included in the invention.

Furthermore, the invention also relates to a cooling device for a battery module, wherein the cooling device has an inter-cell cooling device according to the invention or one of its embodiments. In addition, the cooling device can also comprise several such inter-cell cooling devices.

According to a further advantageous embodiment of the invention, the cooling device has a control device for controlling a coolant flow through the inter-cell cooling device and for controlling the heating device, wherein the control device is designed to control the coolant flow and the heating device in such a way that no coolant flows through the inter-cell cooling device or only flows through it to a reduced extent when the heating device is in an active heating state. This ensures that the heat generated by the heating device is not immediately carried away by the coolant flow. This allows even more efficient heating of the adjacent battery cells.

The cooling device can also comprise a cooling channel in which a coolant, preferably a liquid coolant, can be circulated and is circulated during operation. In addition, the cooling device can comprise further cooling devices in addition to the inter-cell cooling device. In addition, the cooling device can have at least one coolant pump for conveying the coolant through the cooling channel. The flow of coolant through the inter-cell cooling device can be achieved by activating the pump. If, on the other hand, the heating device is activated, the coolant pump can be deactivated by the control device or at least its pumping power can be reduced.

The control device can have a data processing device or a processor device which is set up to perform a corresponding cooling method. For this purpose, the processor device can have at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can be used as a microprocessor. Furthermore, the processor device can have program code which is configured to carry out the embodiment of the cooling method according to the invention when it is executed by the processor device. The program code can be stored in a data memory of the processor device. The processor device can be based, for example, on at least one circuit board and/or at least one SoC (System on Chip).

The invention also includes developments of the battery module according to the invention and of the cooling device according to the invention, which have the same features which have already been described in conjunction with the developments of the inter-cell cooling device according to the invention. For this reason, the corresponding developments of the battery module according to the invention and of the cooling device according to the invention are not described again here.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic and perspective illustration of an inter-cell cooling device according to an exemplary embodiment of the invention;

FIG. 2 shows a schematic cross-sectional illustration of the inter-cell cooling device of FIG. 1 according to an exemplary embodiment of the invention;

FIG. 3 shows a detailed view of the schematic cross-sectional illustration of an inter-cell cooling device of FIG. 2 according to an exemplary embodiment of the invention;

FIG. 4 shows a schematic cross-sectional illustration of an inter-cell cooling device according to another exemplary embodiment of the invention;

FIG. 5 shows a schematic cross-sectional illustration of a further inter-cell cooling device according to one exemplary embodiment of the invention;

FIG. 6 shows a schematic cross-sectional illustration of an inter-cell cooling device according to a further exemplary embodiment of the invention;

FIG. 7 shows a schematic illustration of a battery module in a plan view during cooling of the battery cells by means of inter-cell cooling devices according to an exemplary embodiment of the invention; and

FIG. 8 shows a schematic illustration of a battery module of FIG. 7 in a heating operation according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

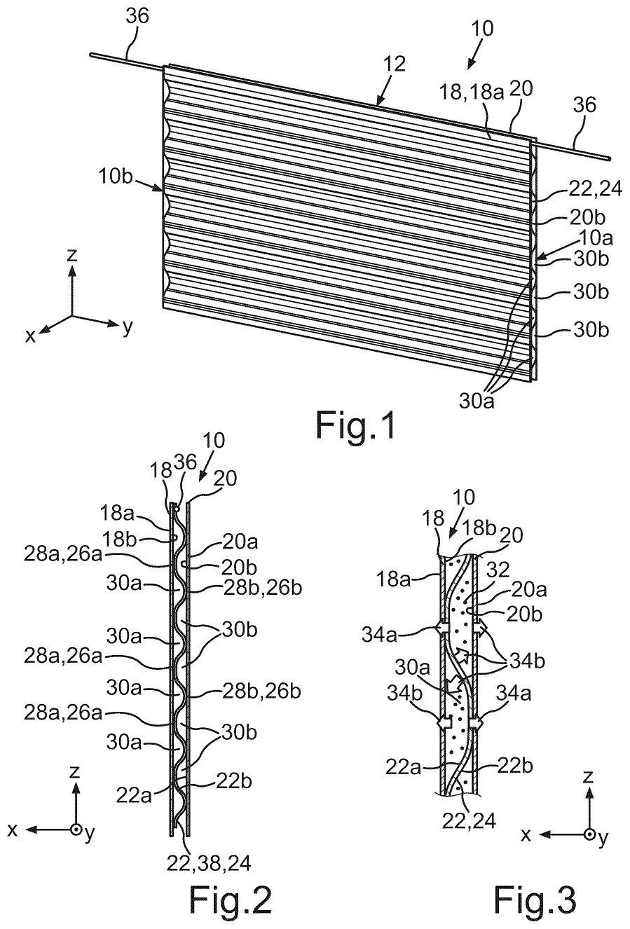

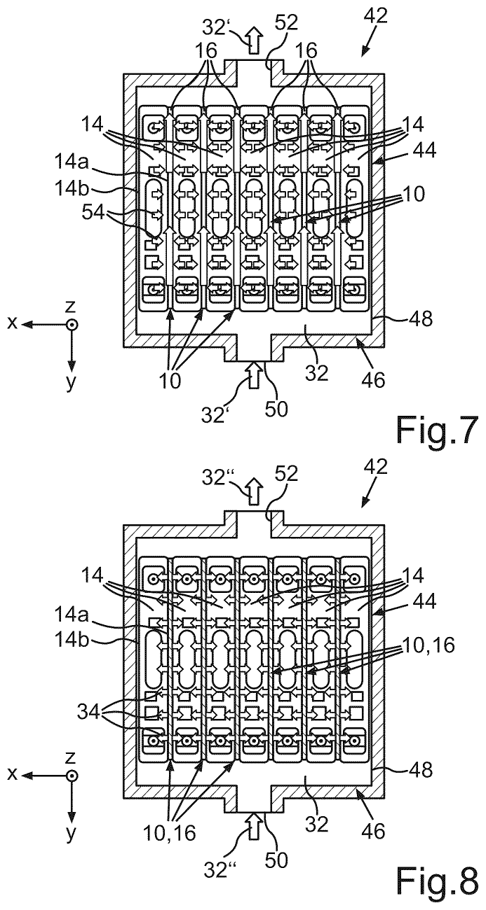

FIG. 1 shows a schematic illustration of an inter-cell cooling device 10 according to an exemplary embodiment of the invention. The inter-cell cooling device 10 has a central inter-cell cooling region 12 which, when the inter-cell cooling device 10 is arranged as intended, is arranged between two battery cells 14 (see FIG. 7) within an intermediate space 16 between these battery cells 14 (see FIG. 7). In this example, the inter-cell cooling device 10 has two side walls 18, 20, between which an intermediate wall 22 is arranged. The side walls 18, 20 are preferably designed as flat sheets, but can in principle be made of any material. In addition, in this example, the inter-cell cooling device 10 comprises a heating device in the form of a heating layer 24, which is simultaneously provided by the intermediate wall 22. In other words, the intermediate wall 22 is designed as a heating device or heating layer 24. Furthermore, in this example the intermediate wall 22 is corrugated. This means it has a corrugated structure.

FIG. 2 shows a schematic cross-sectional view of the inter-cell cooling device 10 from FIG. 1. FIG. 3 shows another schematic detailed view of the cross-sectional view from FIG. 2. FIG. 1 to FIG. 3 are therefore discussed together below.

The first side wall 18 has an outer side 18a and an inner side 18b. Likewise, the second side wall 20 has an outer side 20a and an inner side 20b. The intermediate wall 22 also comprises a first wall side 22a and an opposite second wall side 22b. The corrugated structure of the intermediate wall 22 results in elevations 26a and depressions 26b of the intermediate wall pointing in the x-direction. The regions of the elevations 26a of the intermediate wall 22 simultaneously represent connection regions 28a for connecting the intermediate wall 22 and the inner side 18b of the first side wall, and the depressions 26b simultaneously represent connection regions 28b for connecting the side wall 22 to the inner side 20b of the second side wall 20. The side walls 18, 20 and the intermediate wall 22 can be glued or welded together at these connection regions 28a, 28b or joined by another method. This structure results in multiple first cooling channels 30a between the intermediate wall 22 and the first side wall 18 and multiple second cooling channels 30b between the intermediate wall 22 and the second side wall 20 between the two intermediate walls 18, 20. In this example, the cooling channels 30a, 30b run parallel to each other and in the y-direction. The cooling channels 30a, 30b can thus advantageously be flowed through by a coolant 32, as illustrated in FIG. 3. If the heating layer 24 integrated into the intermediate wall 22 is activated, heat 34a, 34b is emitted, which is transferred via the side walls 18, 20 to the adjacent cell sides of the battery cells 14. In this example, there are two transfer paths, namely a first path, via which the heat 34a is transferred and which leads from the intermediate wall 22 directly via one of the side walls 18, 20 to the cell sides, and a second transfer path, via which the heat 34b is transferred and which leads from the intermediate wall 22 via the cooling medium 32 and one of the side walls 18, 20 to the adjacent cell sides. To heat the heating layer 24, a heating voltage is applied thereto. This is done via two electrical connections 36, which can also be part of the inter-cell cooling device 10. However, these are located outside the central inter-cell cooling region 12.

The heating structure 26 is therefore preferably located between the two outer sheets 18, 20 and is preferably designed as a corrugated structure. This simultaneously enables a good thermal connection to the fluid 32 and to the two outer surfaces 18a, 20a, an enlargement of the heating surface and the definition of the required flow cross-section. In other words, in this case the intermediate wall 22 can simultaneously function as a support element 38 due to its corrugated structure in order to support the two side walls 18, 20 against each other and thereby always ensure a minimum flow-through cross-section of the cooling channels 30a, 30b. A non-planar design of the intermediate wall 22 advantageously enables an increase in the heating surface provided by the surface of both the first wall side 22a and the second wall side 22b.

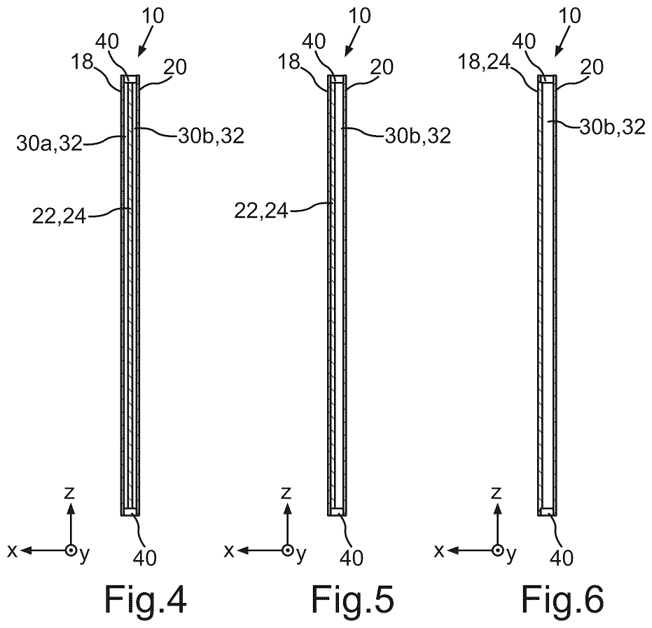

However, numerous other possible designs of the heating layer 24 are conceivable, as will be explained below with reference to FIG. 4 to FIG. 6.

FIG. 4 to FIG. 6 each show a schematic cross-sectional representation of an inter-cell cooling device 10 according to respective further embodiments of the invention. According to the example shown in FIG. 4, the heating device 24 is again integrated into the intermediate wall 22, but in the present example the intermediate wall 22 is designed as a flat wall which is located essentially at an equal distance from the first and second side walls 18, 20, i.e. in the middle of the first and second side walls 18, 20 with respect to the x-direction shown. Otherwise, the inter-cell cooling device 10 can be designed as previously described. In order to support the two side walls 18, 20 against each other, the inter-cell cooling device 10 also includes lateral spacers 40, which are arranged in a respective edge region between the two side walls 18, 20 with respect to the z-direction shown. A centrally arranged heating element 24 provided by the intermediate wall 22 enables both side walls 18, 20 to be heated particularly evenly.

In the example shown in FIG. 5, the intermediate wall 22 with the integrated heating structure 24 is arranged off-center with respect to the first and second side walls 18, 20 and can, for example, be arranged directly on one of the two side walls, in this case a first side wall 18. Here, too, edge-side support elements 40 are provided with respect to the z-direction in order to ensure a certain minimum distance between the two side walls 18, 20.

According to the example shown in FIG. 6, the inter-cell cooling device 10 does not comprise an intermediate wall. Instead, in this example, the heating layer 24 is integrated into one of the two side walls 18, 20, in this case into the first side wall 18. In other words, the side wall 18 in the present example can itself be designed as a heating wall 24. In this example, support elements 40 are again provided, which are arranged between the side walls 18, 20 in the two edge regions of the side walls 18, 20 that are opposite one another with respect to the z-direction.

The end faces 10a, 10b of the inter-cell cooling device 10, which are opposite each other with respect to the illustrated y-direction, can be designed to be open. In other words, the cooling channels 30a, 30b are not sealed on these end faces 10a, 10b. This allows an open flow of a cooling medium 32 through the inter-cell cooling device 10. The same applies to the embodiments shown in FIG. 4 to FIG. 6. Alternatively, the end faces 10a, 10b can also be designed to be sealed, and the inter-cell cooling device 10 can additionally have a coolant supply connection and a coolant discharge connection in order to supply a coolant to the cooling channels 30a, 30b or to discharge it from them.

FIG. 7 shows a schematic representation of a battery module 42 in a plan view from above, in the z direction shown. The battery module 42 has a cell stack 44, which in turn comprises multiple battery cells 14 arranged adjacent to one another in a stacking direction, wherein the stacking direction presently corresponds to the x-direction shown. An intermediate space 16 is arranged between each two adjacent battery cells 14, in which intermediate space a respective inter-cell cooling device 10 is arranged.

Each cell 14 has two cell sides 14a, 14b opposite each other in the x-direction. One of these two cell sides 14a, 14b adjoins the respective side wall 18, 20 of the inter-cell cooling device 10, in particular in a flat manner. In this example, the inter-cell cooling devices 10 are used in a cooling operation of a cooling device 46 comprising them. The cooling device 46 can, for example, comprise a housing 48 through which the coolant 32 can flow, which can also be part of the battery module 42 and in which the cell stack 44 is arranged. The housing 48 can correspondingly be designed to be fluid-tight. In this example, the poles of the cells 14 are located at the top relative to the z-direction and the cooling device 46 can be designed such that only the lower part of the housing 48 relative to the z-direction is flowed through by the coolant 32, so that the poles cannot come into contact with the coolant 32. Alternatively, the entire housing 48 can be flowed through, e.g. if the coolant 32 is a gas or an electrically non-conductive liquid coolant 32.

In addition, the cooling device 46 includes a coolant supply connection 50 and a coolant discharge connection 52. An appropriate coolant flow 32′, as illustrated by the arrow, can be fed to the cooling device 46 via the supply connection 50, and a corresponding coolant flow 32′ can be returned from the discharge connection 52. In this example shown, the respective heating devices 24 of the respective inter-cell cooling devices 10 are in the deactivated state. In this example, the cells 14 are to be cooled by means of the coolant 32. The cells 14 release heat 54 to the coolant 32 flowing through the cooling channels 30a, 30b of the inter-cell cooling devices 10. The coolant 32 heated thereby is discharged via the discharge connection 52.

FIG. 8 shows a schematic representation of the battery module 42 from FIG. 7 in a heating mode. The battery module 42 can be constructed as described in FIG. 7. In this example, the cells 14 are heated by means of the respective inter-cell cooling devices 10. In this state, the respective heating devices 24 of the respective inter-cell cooling devices 10 are correspondingly energized via their respective connections 36 and thus generate heat. The heating structures 24 accordingly release this heat 34 to the cells 14, as previously described.

In order to make heating even more efficient, it is also envisaged that the cooling device 46 will reduce or completely block the coolant flow 32″, which is fed to the supply connection 50 in the heating mode, compared to the one in the cooling mode. In the “Heat battery” mode, as shown in FIG. 8, the volumetric flow is thus greatly reduced by the battery system 42 or by the individual inter-cell cooling devices 10 respectively, or the flow is completely switched off to reduce the heat loss to the cooling system and the periphery.

When heated, the heating structure 24 transfers heat 34 directly to the outer sheets 18, 20 or the cooling fluid 32 and thus heats the cells 14.

Overall, the examples show how the invention can provide inter-cell cooler with integrated heating structure. By combining an inter-cell cooling plate with a heating structure in one component, both the cooling and heating performance can be improved. Heat losses in the components of the cooling circuit and the peripherals are minimized. Battery cells, especially lithium-ion cells, exhibit reduced performance in temperature ranges below 25° C. This means that with conventional battery systems, full power cannot be immediately accessed during vehicle operation at low temperatures. Even when charging, the cell does not absorb the maximum possible power in the lower temperature range below 25° C. This in turn leads to longer charging times for conventional battery systems. By means of the invention and its embodiments, it is now advantageously possible to heat the battery system effectively and energy efficiently, in particular when required, for example when the cell temperature is in a temperature range below 25° C. By directly integrating the heating structure into the inter-cell cooling device, heat losses in the components of the cooling circuit and the resulting unwanted release of heating power to the environment can be avoided or reduced to a minimum.

1. An inter-cell cooling device for arrangement in an intermediate space between two battery cells of a cell stack arranged adjacent to one another in a stacking direction, wherein the part of the inter-cell cooling device which, when the inter-cell cooling device is arranged in the intermediate space, is located entirely within the intermediate space, represents a central inter-cell cooling region, wherein the inter-cell cooling device comprises:
a first side wall with a first outer side for arrangement on a first cell side of one of the two adjacent battery cells;
a second side wall opposite the first side wall with respect to a first direction and having a second outer side for arrangement on a second cell side of the other of the two adjacent battery cells; and
a heating device designed as a heating layer for heating the inter-cell cooling devices,
wherein with respect to the first direction, at least one cooling channel through which a coolant can flow, is formed between the first and second side wall as part of the central inter-cell cooling region, and the heating layer is designed to heat a coolant located in the at least one cooling channel.

2. The inter-cell cooling device according to claim 1, wherein the heating layer is formed as the first and/or second side wall and/or is integrated into the first and/or second side wall.

3. The inter-cell cooling device according to claim 1, further comprising: an intermediate wall which is arranged between the first and second side wall with respect to the first direction, wherein the heating layer is designed as the intermediate wall and/or is part of the intermediate wall.

4. The inter-cell cooling device according to claim 1, wherein the heating layer extends over a majority of a length and width of the central inter-cell cooling region and preferably over an entire length and width of the central inter-cell cooling region perpendicular to the first direction.

5. The inter-cell cooling device according to claim 1, wherein the inter-cell cooling device in the central inter-cell cooling region comprises at least one support element which is arranged in contact on a first inner side of the first side wall opposite the first outer side of the first side wall, on the one hand, and on a second inner side of the second side wall opposite the second outer side of the second side wall, on the other hand, and which locally supports the first side wall against the second side wall.

6. The inter-cell cooling device according to claim 3, wherein the at least one support element is provided by the intermediate wall.

7. The inter-cell cooling device according to claim 3, the intermediate wall has a first wall side and a second wall side opposite the first wall side with respect to the first direction, wherein a distance of the first wall side from the second wall side defines a wall thickness of the intermediate wall, wherein the first wall side and/or the second wall side is formed with a surface geometry different from a plane, and the first wall side locally contacts the first inner side and the second wall side locally contacts the second inner side, in particular wherein the intermediate wall has a substantially constant wall thickness in the central inter-cell cooling region.

8. The inter-cell cooling device according to claim 3, wherein the intermediate wall:
has multiple elevations and depressions in the first direction with respect to an imaginary center plane perpendicular to the first direction; and/or
is corrugated; and/or
has a zigzag profile; and/or
has a meandering profile.

9. A battery module with an inter-cell cooling device, according to claim 1, and with a cell stack, which comprises at least two battery cells arranged adjacent to one another in a stacking direction, wherein the inter-cell cooling device is arranged in an intermediate space between the two battery cells.

10. A cooling device for a battery module, wherein the cooling device has an inter-cell cooling device according to claim 1, and a control device for controlling a coolant flow through the inter-cell cooling device and for controlling the heating device, wherein the control device is designed to control the coolant flow and the heating device in such a way that the inter-cell cooling device is not flown through by a coolant when the heating device is in an active heating state.

11. The inter-cell cooling device according to claim 2, further comprising: an intermediate wall which is arranged between the first and second side wall with respect to the first direction, wherein the heating layer is designed as the intermediate wall and/or is part of the intermediate wall.

12. The inter-cell cooling device according to claim 2, wherein the heating layer extends over a majority of a length and width of the central inter-cell cooling region and preferably over an entire length and width of the central inter-cell cooling region perpendicular to the first direction.

13. The inter-cell cooling device according to claim 3, wherein the heating layer extends over a majority of a length and width of the central inter-cell cooling region and preferably over an entire length and width of the central inter-cell cooling region perpendicular to the first direction.

14. The inter-cell cooling device according to claim 2, wherein the inter-cell cooling device in the central inter-cell cooling region comprises at least one support element which is arranged in contact on a first inner side of the first side wall opposite the first outer side of the first side wall, on the one hand, and on a second inner side of the second side wall opposite the second outer side of the second side wall, on the other hand, and which locally supports the first side wall against the second side wall.

15. The inter-cell cooling device according to claim 3, wherein the inter-cell cooling device in the central inter-cell cooling region comprises at least one support element which is arranged in contact on a first inner side of the first side wall opposite the first outer side of the first side wall, on the one hand, and on a second inner side of the second side wall opposite the second outer side of the second side wall, on the other hand, and which locally supports the first side wall against the second side wall.

16. The inter-cell cooling device according to claim 4, wherein the inter-cell cooling device in the central inter-cell cooling region comprises at least one support element which is arranged in contact on a first inner side of the first side wall opposite the first outer side of the first side wall, on the one hand, and on a second inner side of the second side wall opposite the second outer side of the second side wall, on the other hand, and which locally supports the first side wall against the second side wall.

17. The inter-cell cooling device according to claim 4, wherein the at least one support element is provided by the intermediate wall.

18. The inter-cell cooling device according to claim 5, wherein the at least one support element is provided by the intermediate wall.

19. The inter-cell cooling device according to claim 4, the intermediate wall has a first wall side and a second wall side opposite the first wall side with respect to the first direction, wherein a distance of the first wall side from the second wall side defines a wall thickness of the intermediate wall, wherein the first wall side and/or the second wall side is formed with a surface geometry different from a plane, and the first wall side locally contacts the first inner side and the second wall side locally contacts the second inner side, in particular wherein the intermediate wall has a substantially constant wall thickness in the central inter-cell cooling region.

20. The inter-cell cooling device according to claim 5, the intermediate wall has a first wall side and a second wall side opposite the first wall side with respect to the first direction, wherein a distance of the first wall side from the second wall side defines a wall thickness of the intermediate wall, wherein the first wall side and/or the second wall side is formed with a surface geometry different from a plane, and the first wall side locally contacts the first inner side and the second wall side locally contacts the second inner side, in particular wherein the intermediate wall has a substantially constant wall thickness in the central inter-cell cooling region.
